(19) United States
(12) Patent Application Publication
(10) Pub. No.: US 2007/0086195 A1
(43) Pub. Date: Apr. 19, 2007

(54) Lighting armature

(76) Inventor: Jan Marinus Geluk, Herwijnen (NL)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/522,096

(22) Filed: Sep. 15, 2006

(30) Foreign Application Priority Data
Sep. 21, 2005 (NL) 1029999

(51) Int. Cl. F21V 29/00

(52) U.S. Cl. 362/294

(57) ABSTRACT

The invention relates to a lighting fixture comprising a housing, a primary light source, and a secondary light source. The primary and the secondary light source are placed in the housing. The lighting fixture further comprises a reflector for reflecting light originating from the primary light source in a desired direction. The secondary light source comprises at least one light-emitting diode for providing light after the occurrence of an explosion in the vicinity of the lighting fixture.

### FIELD OF THE INVENTION

The present invention relates to a lighting fixture comprising a housing, a primary light source, and a secondary light source, with the primary and the secondary light source placed in the housing, and further comprising a reflector for reflecting light originating from the primary light source in a desired direction.

### BACKGROUND OF THE INVENTION

The secondary light source supports the operation of the primary light source in such a lighting fixture when the primary light source becomes defective, for example in emergency lighting applications. This provides the advantage that the lighting is still operative and can still illuminate, for example, the surroundings for the purpose of a possibly necessary evacuation and other activities to be carried out in the case of calamities.

Although the use of secondary light sources in such a lighting fixture guarantees a long-term operation of the latter, the operational reliability of such a lighting fixture would seem not to be guaranteed in major calamities such as, for example, explosions or extreme external conditions such as a heavy storm. Such forces and stresses applied to the lighting fixture from the outside may indeed have the effect that both the primary and the secondary light source become defective and that the lighting fixture itself also becomes inoperative owing to the occurrence of the calamity.

If the lighting fixture is used for industrial purposes, for example on oil platforms, in factory surroundings, or in (major) building projects, it is conceivable that such lighting fixtures are used under extreme conditions where in addition an increased risk exists of serious calamities occurring, for example an explosion. Conventional lighting fixtures are insufficiently capable of complying with the requirements regarding safety at work under such conditions.

### SUMMARY OF THE INVENTION

It is accordingly an object of the invention to provide a lighting fixture which eliminates the disadvantages of the prior art as described above and which is designed to be operative after the occurrence of a calamity in which the lighting fixture was exposed to major external forces.

To achieve this object, the present invention provides a lighting fixture comprising a housing, a primary light source, and a secondary light source, with the primary and the secondary light source placed in the housing, and further comprising a reflector for reflecting light originating from the primary light source in a desired direction, wherein the secondary light source comprises at least one light-emitting diode for providing light after the occurrence of an explosion in the vicinity of the lighting fixture.

The lighting fixture according to the invention, in particular its secondary light source, comprises at least one light-emitting diode. It is known that light-emitting diodes can be exposed to comparatively great external forces without their operation being significantly affected thereby. In particular, there are light-emitting diodes capable of withstanding acceleration forces of 12 g, and which are accordingly capable of withstanding an explosion, in which usually forces of approximately 7 g are released. The use of light-emitting diodes (LEDs) as a secondary light source thus ensures that such a lighting fixture can still emit light even after exposure to major external forces (such as an explosion) and can illuminate an escape route, if so desired.

According to a further embodiment of the invention, the at least one light-emitting diode comprises a substrate for providing light, and the at least one light-emitting diode is arranged such that said substrate is present at a side of the reflector facing away from the primary light source so as to counteract a transfer of radiation energy from the primary light source to the substrate.

Such an embodiment provides the advantage that there will be substantially no heat transfer between a, for example operating, primary light source and the secondary light sources formed by the light-emitting diodes, which are also accommodated in the lighting fixture. If a light-emitting diode becomes too hot, its operation will be adversely affected, and at elevated temperatures (of the order of 150° C.) the light-emitting diode may even become defective. The primary light source accommodated in the lighting fixture will release a comparatively large amount of radiation energy to its surroundings (for example for illuminating the latter), especially in an industrial environment. If the radiation energy of the primary light source can reach the substrate of the light-emitting diode, there will be a heat transfer process which causes the temperature of the light-emitting diode to rise. A placement of the light-emitting diodes according to the invention such that the substrate is behind the reflector as seen from the primary light source will screen off the substrate sufficiently from a generated radiation, so that heat transfer between the primary light source and the secondary light source owing to radiation is reduced to a minimum. This renders it possible to keep the temperature of the at least one light-emitting diode of the secondary light source under control even where a primary light source of high intensity, emitting a large amount of radiation energy, is used.

According to a further preferred embodiment, the at least one light-emitting diode comprises a diode housing for allowing the light provided by the diode to be emitted, which diode housing is passed through the reflector such that the diode housing is present at least in part at a side of the reflector that faces the primary light source. It should be understood that the side of the reflector that faces the primary light source will also be the side having the highest reflectivity. Light issuing from the at least one light-emitting diode in the diode housing will be effectively reflected in a desired direction by the reflector.

The fact that the diode housing is passed through the reflector, for example through a perforation in the reflector itself, can achieve in particular that the substrate of the light-emitting diode lies behind the reflector as seen from the primary light source, while the diode housing of the at least one light-emitting diode is positioned at the reflecting side of the reflector that faces the primary light source. This latter embodiment achieves the advantages both of counteracting a heat transfer through radiation between the primary light source and the secondary light source and of utilizing the effective surface area of the reflector (having the high reflectivity) for directing the light coming from the light-emitting diodes.

According to a further embodiment, the housing of the lighting fixture comprises a cooling element for removing heat from said housing. Those skilled in the art will appreciate that the use of a suitable cooling element provides a sufficiently strong heat exchange with the environment such that the temperatures inside the lighting fixture are kept within bounds. In a further embodiment, the at least one light-emitting diode of the secondary light source may be placed on the cooling element for the purpose of transferring heat from the at least one light-emitting diode to the cooling element. The heat from the light-emitting diode can thus be directly removed to the cooling element, and from the cooling element to the environment. Possibly, the at least one light-emitting diode may be placed in a thermally conducting paste for increasing the heat transfer between the light-emitting diode and the cooling element.

According to a further embodiment, the at least one light-emitting diode is placed on a thermally conducting arm that is connected to the cooling element. Such an arm may extend from the cooling element to the side of the reflector facing away from the primary light source, and the light-emitting diode may be placed thereon such that the substrate is present behind the reflector. The length and shape of the arm may be suitably chosen so as to fit the shape of the reflector and the correct placement of the light-emitting diodes.

According to a further embodiment, the reflector of the lighting fixture is located such that it is in thermally conductive contact with the cooling element. Any heat transferred to the reflector (for example owing to radiation and/or thermal contact with either the primary or the secondary light source) can thus be efficiently removed and transferred to the environment, so that the temperature inside the lighting fixture can be kept under control. The reflector may be placed directly on the cooling element, if so desired. This achieves a good heat transfer This heat transfer can be additionally increased in that a thermally conducting paste is provided between the reflector and the cooling element.

Those skilled in the art will appreciate that the temperature inside the lighting fixture can be best controlled when those components of the lighting fixture that heat up quickly and reach a comparatively high temperature are in good thermal contact with the cooling element. It is further noted in connection with the above that the heat generation in the light-emitting diode itself may also be high. A good thermal contact between the cooling element and the light-emitting diodes is accordingly desirable if a good control of the temperature in the lighting fixture is to be achieved.

According to a further embodiment, the lighting fixture comprises independent current supply means. Said independent current supply means may comprise, for example, a voltaic cell or an accumulator battery, or other means in which energy can be stored so as to be converted at a later stage into electrical energy for powering the primary or secondary light source of the lighting fixture. Such independent current supply means can still operate the lighting fixture, for example after a failure of the power in a public electric power distribution network, for illuminating an emergency exit or evacuation route, for example.

According to a further embodiment, the current supply means comprise an accumulator battery, and the lighting fixture further comprises means for charging said accumulator battery by means of electric power from a public electric power distribution network. In such a lighting fixture, the accumulator battery can be charged during normal operation and under normal conditions while the power network is available, so that upon a possible failure of the power in the network the accumulator battery can take over the power supply to the lighting fixture for powering the primary or secondary light source.

According to a further embodiment, the means for charging are designed to adapt a charging voltage for charging the accumulator battery in dependence on the temperature of the accumulator battery. The adaptation of the charging voltage to the prevailing temperature of the accumulator battery will prolong the operational life of the battery considerably, so that the lighting fixture can operate without maintenance for a long period (for example for 10 years or possibly even longer). A suitable control of the charging voltage can also achieve that no hydrogen gas is evolved during charging and discharging of the voltaic cell or accumulator battery. Hydrogen gas is highly explosive, as is generally known, so an incorrect manner of charging of the accumulator battery can increase the risk of explosions occurring. This risk is reduced to a minimum with this embodiment of the lighting fixture. In particular, the charging voltage may be adapted so as to be inversely proportional to the temperature of the accumulator battery. This is to say that the charging voltage applied across the battery is high when the battery has a low temperature, while a low charging voltage is used when the battery has a high temperature.

According to a further embodiment, the lighting fixture may be provided with control means for controlling the operation of the lighting fixture. Said control means may consist of, for example, an electronic circuit for driving the primary and secondary light sources. Said electronic circuit should be protected from moisture and high temperatures so as to guarantee a long life of the lighting fixture. It is additionally important for such an electronic circuit, when used in specific industrial installations, to be constructed in an explosion-proof manner in accordance with legally binding standards. This means that the electronic circuit included in the lighting fixture must not constitute a risk as regards the explosion safety of the industrial installation. To achieve this, the electronic circuit, or more generally the control means, may be embedded in a hydrophobic sand such as quartz sand. The use of such a sand provides a good heat transfer between the electronic circuit and the cooling element and also provides a good moisture protection. In particular, this sand may be vibrated such that no air is present any more between the grains of sand after the electronic circuit has been incorporated in the lighting fixture. The elimination of air in the vicinity of the electronic circuit in this manner benefits the temperature balance and controllability, and the prevention of a free air volume inside the lighting fixture, thus improving the explosion safety.

According to a further embodiment, the control means may comprise communication means for providing and transmitting status information regarding the lighting fixture. This status information may be received, for example, at a central station or may be passed on wirelessly to a telephone network, whereupon it can be transmitted to a central server. It can thus be centrally verified what the operational status of the lighting fixture is, and appropriate action can be taken in the case of a defect.

In a lighting fixture according to a further embodiment, the control means further comprise a signal input for adapting the operation of the lighting fixture in dependence on a signal received at said signal input. The operation of the lighting fixture thus becomes controllable from the outside. In particular, for example, the control of the operation of the lighting fixture may be made dependent on the presence or absence of personnel in the vicinity of the lighting fixture, or the presence of personnel who are to be evacuated via an evacuation route that passes along the lighting fixture in the case of an emergency. This provides advantages in particular for the use of such a lighting fixture in applications such as, for example, oil or gas production platforms, because oil or gas production platforms often remain unattended for a certain period, maintenance personnel being present on the platform at certain intervals only. When maintenance personnel enter the production platform, the safety instructions require that certain actions are carried out, such as the activation of a navigation system. Such actions may be signaled in a comparatively simple manner and passed on to the control means of the lighting fixture. The control means thereupon adapt the operation of the lighting fixture to the new, manned situation of the oil or gas production platform.

According to a further embodiment of the invention, the primary light source is operationally at least connected to the public electric power distribution network for being energized, and the secondary light source is operationally at least connected to the independent current supply means. It is achieved thereby that the secondary light source can always be energized independently of the power distribution network, while the regular power supply for energizing the primary light source can be obtained from the power distribution network. According to another embodiment of the invention, furthermore, the control means may be designed to cause the secondary light source to be switched on gradually when the network power fails so as to counteract a stepwise load being applied to the independent current supply means. It should be appreciated that a stepwise or sudden load on the current supply means detracts from the life expectancy of the independent current supply means. If a long, maintenance-free life of the lighting fixture is to be guaranteed, therefore, a stepwise load on the independent current supply means, for example a battery, is not desirable.

According to a further embodiment, the lighting fixture comprises a light sensor for measuring the illumination level of the surroundings in which the lighting fixture is placed. The signals from such a light sensor can be passed on to the control means, which can adapt the operation of the lighting fixture to the instantaneous lighting situation. If the surroundings are well lit (for example during the day or during normal work at night), it may well be that switching on of the lighting fixture provides no added value, and the control means may be designed to switch off the lighting fixture. If the quantity of ambient light is small, however, or if the lighting fixture is surrounded by smoke, the light sensor will measure a low light intensity, and the control means may de designed to energize the lighting fixture. If possible, the control means may be designed to adapt the energizing current for the secondary light source in dependence on the illumination level measured by the light sensor. This ensures, for example in the case of an emergency situation, that the secondary light source does not consume more electric power than is necessary for an adequate lighting of the surroundings. The duration of operation of the lighting fixture in a calamity, for example with the main power supply (the electric power distribution network) being down, can thus be prolonged, while at the same time the chance of escape for persons present near the lighting fixture is proportionally improved.

As was described above, the lighting fixture is used as an emergency lighting fixture in a further embodiment.

### BRIEF DESCRIPTION OF THE DRAWINGS

Further features and advantages of the invention will be described with reference to a few specific embodiments of the invention illustrated by the appended drawings, in which:

FIG. 1 is a side elevation of a lighting fixture according to the present invention;

FIG. 2 is a plan view of the lighting fixture shown in FIG. 1; and

FIGS. 3A and 3B are an enlarged view and a cross-sectional view, respectively, of a light-emitting diode passed through a reflector.

### DETAILED DESCRIPTION OF THE PREFERRED EMBODIMENTS

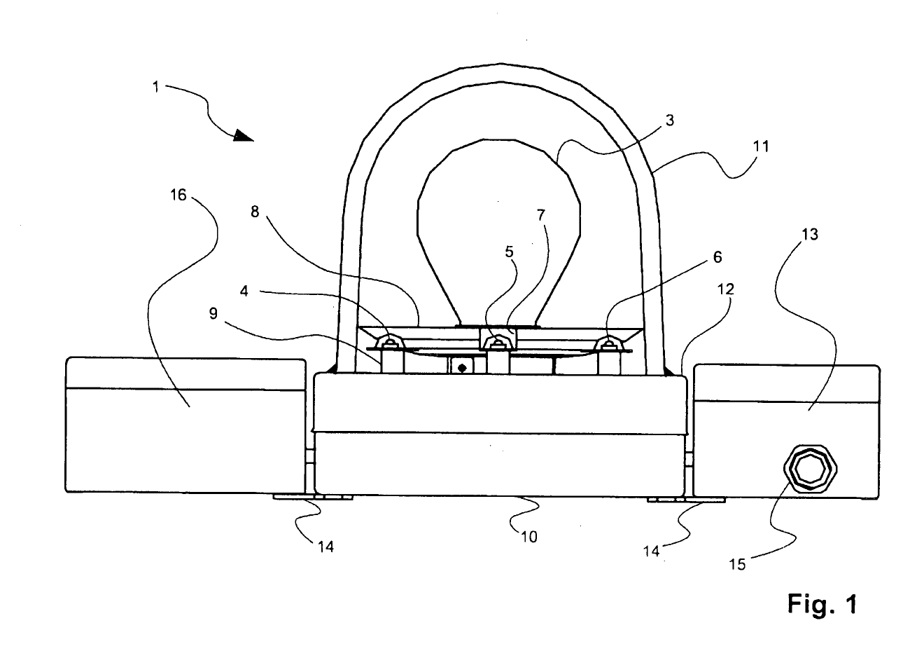

FIG. 1 shows a lighting fixture 1 according to the present invention. The lighting fixture 1 comprises a primary light source 3 of a suitable type. The primary light source 3 may comprise any suitable type of light source, but good results as regards explosion safety and life of such a lighting fixture are obtained when, for example, a QL lamp is used with suitable ballast equipment (for example as supplied by IMT B.V. under the type designations IQL 85 and IQL 165). Other lamps that may be used as the primary light source 3 in the lighting fixture 1 shown in FIG. 1 are, for example, TL (tubular fluorescent) lamps and lamps having a comparatively long life.

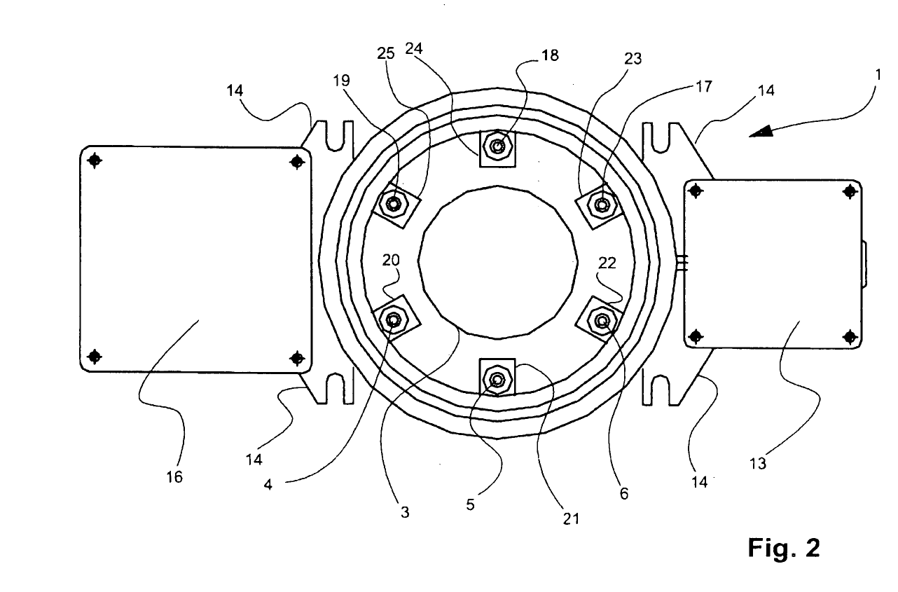

The lighting fixture 1 further comprises a secondary light source comprising a plurality of light-emitting diodes (such as light-emitting diodes 4, 5, and 6). The number of light-emitting diodes used may depend on specific design choices. The lighting fixture 1 shown in FIG. 1 is also shown in plan view in FIG. 2 and comprises a total of six light-emitting diodes 4, 5, 6, 17, 18, and 19, which are arranged around the primary light source 3. When determining the number of light-emitting diodes to be used as the secondary light source one should take into account on the one hand the desired luminous flux to be obtained from the secondary light source and on the other hand the heat generation resulting from the LEDs and the current drawn by them from a battery (if present) against the capacity of this battery (in particular in view of the duration of operation in case of a calamity).

The lighting fixture also comprises a reflector 8 for reflecting light from the primary light source 3 in a desired direction. The shape of the reflecting side of the reflector 8 (this is the side of the reflector 8 facing the light source 3) is such that a desired light distribution can be obtained therewith when the light source 3 is energized. The radiation generated by the light source 3 is effectively reflected by the side of the reflector 8 that faces the light source 3. The reflector 8 comprises a number of recesses, such as recess 7, behind which the light-emitting diodes 4, 5, 6, 17, 18, and 19 are placed in the lighting fixture 1. The light-emitting diodes are positioned such that the substrates of the light-emitting diodes are present at a side of the reflector 8 that faces away from the light source 3; in other words, the substrates are at the rear side of the reflector 8 as seen from the light source 3. This has the advantage that radiation heat of the light source 3 is reflected by the reflector 8 and thus cannot or substantially not reach the substrates of the light-emitting diodes 4, 5, 6, 17, 18, and 19. The heat transfer to the light-emitting diodes 4, 5, 6, 17, 18, and 19 resulting from radiation heat coming from the light source 3 is minimized thereby. At the same time, the LEDs are arranged in the lighting fixture such that they have a good thermally conductive contact with arms 9 which extend from the LEDs in the direction of a cooling block 10 and are connected thereto. The arms 9 may be integral with the cooling block 10, for example in that the arms 9 are formed by extending portions of the cooling block 9. It is also possible to screw the arms 9 into the cooling block 10, in which a thermally conductive paste may be used, if so desired, for obtaining a maximum heat transfer between the cooling block 10 and the arms 9.

The lighting fixture 1 comprises a housing consisting of a translucent cover 11 which is placed over the primary light source 3, the light-emitting diodes 4, 5, 6, 17, 18, and 19, and the reflector 8. The translucent cover 11 is in good thermal contact with the cooling block 10 in that the translucent cover 11 is fastened to the cooling block 10 by means of a ring 12 and a screw connection (not shown), and possibly through the use of a thermally conductive paste for obtaining a maximum heat transfer.

The lighting fixture 1 further comprises a control box 13 in which a connection between the operative parts of the lighting fixture 1 and, for example, a public electric power distribution network can be established. Such a connection should be accessible to maintenance personnel at all times and is accordingly preferably placed in a separately accessible control box such as the control box 13. Such a control box 13 is useful in particular when a so-termed “sealed for life” construction is used, wherein the housing of the lighting fixture is airtight or otherwise fully sealed with respect to the surroundings so as to reduce all interaction with the surroundings (other than for the transmission of light) to a minimum. This improves the performance of the lighting fixture 1 as regards explosion safety.

The lighting fixture shown in FIG. 1 also comprises an additional housing 16 in which a voltaic cell or accumulator battery may be present for supplying the secondary light source 4, 5, 6, 17, 18, 19, the primary light source 3, or both. The control means (not shown) incorporated in the lighting fixture may be able to drive the lighting fixture such that, if the power in the public electric power distribution network should fail, the current supply to the lighting fixture is taken over by the cell or battery present in the housing 16. It is possible that only the secondary light source is powered by the cell or battery so as to maximize the time duration over which the lighting fixture will remain in operation without current being supplied from the public electric power distribution network.

The lighting fixture 1 further comprises fastening means 14 with which the lighting fixture may be suspended or mounted in a working environment, if so desired.

FIG. 2 is a plan view once more showing the lighting fixture 1 described above with reference to FIG. 1. It is noted in this connection that components and features common to FIGS. 1 and 2 have been given the same reference numerals. FIG. 2 shows the lighting fixture 1, primary light source 3, light-emitting diodes 4, 5, 6, 17, 18, and 19, reflector 8, recess 7, fasteneing means 14, control box 13, and external housing 16 for the cell or battery of the lighting fixture 1. Note that FIG. 2 also shows the light-emitting diodes 17, 18, and 19.

The light-emitting diodes 4, 5, 6, 17, 18, and 19 are arranged around the primary light source 3. Each of the diodes 4, 5, 6, 17, 18, and 19 is accommodated in a recess in the reflector 8, i.e. in recess 20, recess 7, recess 22, recess 23, recess 24, and recess 25, respectively.

The plan view also shows the translucent cover 11 of the lighting fixture. The battery used in the lighting fixture, which is present in the external housing 16, may be any suitable type of battery, but good results were obtained with the use of a lead battery. It can be achieved through an accurate charging and discharging of the battery by the control means (not shown) that the battery has a maintenance-free life of at least 10 years and is capable of operating at ambient temperatures of between −40° C. and 40° C. The lighting fixture can thus be reliably operated even under extreme weather conditions. In particular, the charging voltage of the battery may be adapted to the temperature of the battery such that, for example, a comparatively high charging voltage is used in the case of a low battery temperature, whereas a comparatively low charging voltage is used in the case of a high battery temperature. The charging voltage may thus be made inversely proportional to the temperature. The control means may also ensure that the battery is not loaded in an abrupt manner, for example upon a sudden failure of the public electric power distribution network. An even loading of the battery prolongs battery life. As will be appreciated by those skilled in the art, the number and type of voltaic cells or accumulator batteries may be adapted as desired, for example in dependence on the application. The charging voltage across the battery is also controlled by the control means such that the generation of hydrogen gas is avoided. Those skilled in the art are aware that this considerably improves the performance as regards explosion safety.

The lighting fixture 1 may also be provided with light sensors (not shown) which directly detect the quantity of light in the vicinity of the lighting fixture. This achieves that powering of the lighting fixture is made to depend on the demand for additional, supporting light in the surroundings. It can be achieved at the same time that the current through the light-emitting diodes of the secondary light source is increased so as to obtain a higher light intensity in the case of a calamity involving a major smoke generation. In other words, the demand for additional lighting can be adapted to the actual lighting level in the surroundings also in case of calamities.

The control means (not shown) of the lighting fixture 1 may also be designed to communicate any error messages or other status parameters to a central station via a signal line (not shown) or to transmit this information, for example via a telecommunication network. The operation of the lighting fixture can thus be monitored from a distance, so that action can be appropriately taken when a defect occurs. The control means may also be designed to adapt the operation of the lighting fixture to the presence or otherwise of persons in the vicinity of the lighting fixture.

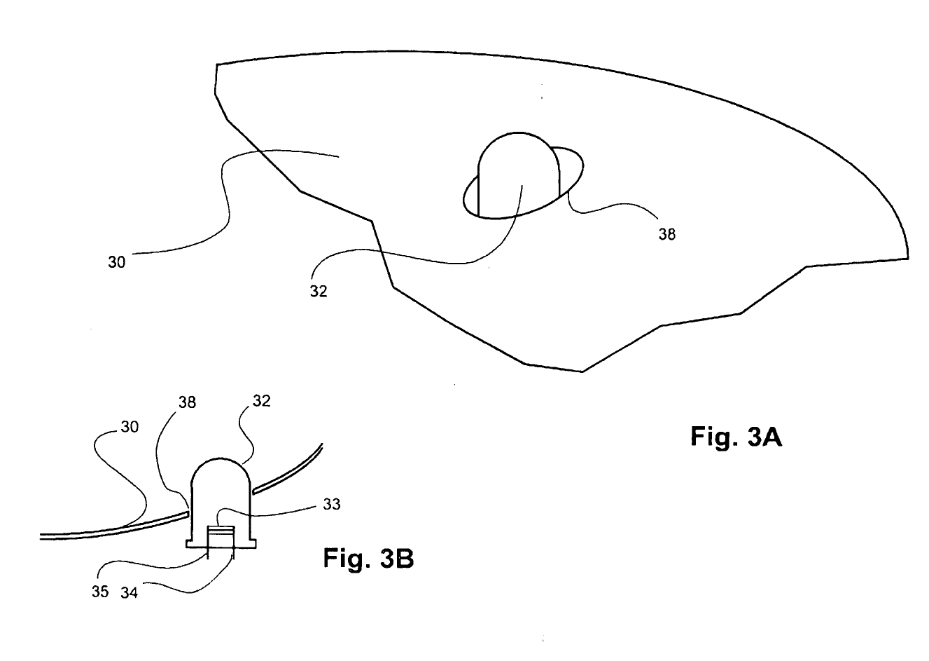

FIGS. 3A and 3B show by way of example how the light-emitting

1. A lighting fixture comprising a housing, a primary light source, and a secondary light source, wherein the primary and the secondary light source are located in the housing, and further comprising a reflector for reflecting light originating from the primary light source in a desired direction, wherein the secondary light source comprises at least one light-emitting diode for providing light after the occurrence of an explosion in the vicinity of the lighting fixture.

2. A lighting fixture according to claim 1, wherein the at least one light-emitting diode comprises a substrate for providing light, and the at least one light-emitting diode is arranged such that said substrate is present at a side of the reflector facing away from the primary light source so as to counteract a transfer of radiation energy from the primary light source to the substrate.

3. A lighting fixture according to claim 1 or 2, wherein the at least one light-emitting diode comprises a diode housing for allowing the light provided by the diode to be emitted, which diode housing is passed through the reflector such that the diode housing is present at least in part at a side of the reflector that faces the primary light source.

4. A lighting fixture according to any one of the preceding claims, wherein the housing further comprises a cooling element for removing heat from said housing.

5. A lighting fixture according to claim 4, wherein the at least one light-emitting diode of the secondary light source is placed on the cooling element so as to transfer heat from the at least one light-emitting diode to the cooling element.

6. A lighting fixture according to claim 5, wherein the at least one light-emitting diode is placed in a thermally conducting paste.

7. A lighting fixture according to any one of the claims 4 to 6, wherein the at least one light-emitting diode is placed on a thermally conducting arm that is connected to the cooling element.

8. A lighting fixture according to any one of the claims 4 to 7, wherein the reflector of the lighting fixture is in thermally conductive contact with the cooling element.

9. A lighting fixture according to claim 8, wherein the reflector is placed on the cooling element.

10. A lighting fixture according to claim 8 or 9, wherein a thermally conducting paste is present between the reflector and the cooling element.

11. A lighting fixture according to any one of the preceding claims, further comprising independent current supply means such as a voltaic cell or an accumulator battery.

12. A lighting fixture according to claim 11, wherein the current supply means comprise an accumulator battery, further comprising means for charging said accumulator battery by means of electric power from a public electric power distribution network.

13. A lighting fixture according to claim 12, wherein the means for charging the accumulator battery are designed to adapt a charging voltage for charging the accumulator battery in dependence on a temperature of the accumulator battery.

14. A lighting fixture according to claim 13, wherein the means for charging the accumulator battery are designed to adapt the charging voltage so as to be inversely proportional to the temperature of the accumulator battery.

15. A lighting fixture according to any one of the preceding claims, further comprising control means for controlling the operation of the lighting fixture.

16. A lighting fixture according to claim 15, wherein said control means are embedded in a hydrophobic sand, such as quartz sand.

17. A lighting fixture according to claim 15 or 16, wherein the control means comprise communication means for providing and transmitting status information regarding the lighting fixture.

18. A lighting fixture according to any one of the claims 15 to 17, wherein the control means further comprise a signal input for adapting the operation of the lighting fixture in dependence on a signal received at said signal input.

19. A lighting fixture according to any one of the preceding claims in dependence on at least one of the claims 11 to 14, wherein the primary light source is operationally at least connected to an electric power distribution network for being energized, and wherein the secondary light source is operationally at least connected to the independent current supply means.

20. A lighting fixture according to claim 19 and at least one of the claims 15 to 18, wherein the control means are designed to cause the secondary light source to be switched on gradually when the network power fails so as to counteract a stepwise load being applied to the independent current supply means.

21. A lighting fixture according to any one of the preceding claims, further comprising a light sensor for measuring an illumination level of an ambience in which the lighting fixture is placed.

22. A lighting fixture according to claim 21, and at least one of the claims 11 to 14, and at least one of the claims 15 to 18 or 20, wherein the secondary light source is operationally at least connected to the independent current supply means, and wherein the control means are designed to adapt the energizing current for the secondary light source in dependence on the illumination level measured by the light sensor.

23. A lighting fixture according to any one of the preceding claims, designed for use as emergency lighting.
